(19) United States
(12) Patent Application Publication
(10) Pub. No.: US 2010/0140390 A1
(43) Pub. Date: Jun. 10, 2010

(54) Flying Wind Energy Conversion Apparatus

(76) Inventor: Peter Robert Goodall, Hertfordshire (GB)

Correspondence Address: Thomas M. Galgano, 20 W. Park Avenue, Suite 204, Long Beach, NY, 11561, US

(21) Appl. No.: 12/223,210

(22) PCT Filed: Jan. 24, 2007
(86) PCT No.: PCT/GB2007/000213

§ 371 Date: Jul. 25, 2008

(30) Foreign Application Priority Data
Jan. 26, 2006 (GB) 0601520.0
Mar. 16, 2006 (GB) 0605304.5

(51) Int. Cl. B64B 1/00; F03D 1/02; H02J 17/00; B64B 1/62; F03D 7/02

(52) U.S. Cl. 244/30; 290/55; 307/151; 244/97; 244/96; 244/24; 416/85

(57) ABSTRACT

A Wind energy conversion apparatus comprising a wind turbine supported by, or integral with, a lighter-than-air structure, the part of the turbine that rotates being rotated by the wind whilst at the same time absorbing substantially all of the force of the wind so that the position of the apparatus can be maintained.

Currently people are considering how to generate electricity from renewable sources such as the wind but this invention looks at the way that wind turbines are mounted or supported and considers a moveable way of positioning the wind turbine to both maximise output and minimise environmental problems.

One problem facing wind turbines mounted or supported by balloons or structures filled with lighter than air gasses such as helium is that the wind that drives the turbine blade of the turbine also applies pressure against the structure on which the wind turbine is mounted or supported.

Even if the Balloon or structures filled with lighter than air gasses such as helium is tethered the wind will try to push the balloon out of position and apply enormous pressure to the cable tethering the structure to the ground.

The problem remains for any balloon or structures filled with lighter than air gasses such as helium on which a wind turbine is mounted or supported is how to overcome the wind pressure against the structure while using it to drive the turbine blade of a wind turbine, so that the balloon or structure filled with lighter than air gas stays in position. The wind may blow the structure out of position unless this problem is overcome or negate or reduce the effectiveness of the wind turbine. If the wind blows the structure along it will not also drive the turbine blade of the wind turbine very quickly. It will also lead to other problems such as how to pass the generated electricity to the ground. Cables carrying the generated electricity would snap. If the balloon was tethered the cable might snap under the pressure.

Also the angle of balloons or structures filled with lighter than air gasses such as helium would change as the wind exerted pressure on the structure and this would make it more difficult to maintain the optimum position of the wind turbine the structure might be supporting relative to the wind. If the wind turbine itself was at an angle relative to the wind it would make it less effective in generating electricity.

According to the present invention there is provided a wind energy conversion apparatus as defined in claim 1. The apparatus may be able to hover at different altitudes taking advantage of higher wind speeds found at higher altitudes than usually found at ground level or on the sea, and can avoid the environmental problems of wind turbines on the ground through noise or affecting the visual appearance of a landscape, and to do so with a mechanism or means that reduces the wind pressure on the structure itself which would tend to push it out of position. The key feature of the invention is that it is designed so that the wind energy is absorbed by the structure by a number of embodiments of the invention so that the wind does not try to push the structure out of position.

This can be achieved in a number of different ways or embodiments of the invention but the same invention is at work, to absorb the wind pressure to maintain the position of the balloon or structure filled with lighter than air gas and so it is not pushed by the wind out of position.

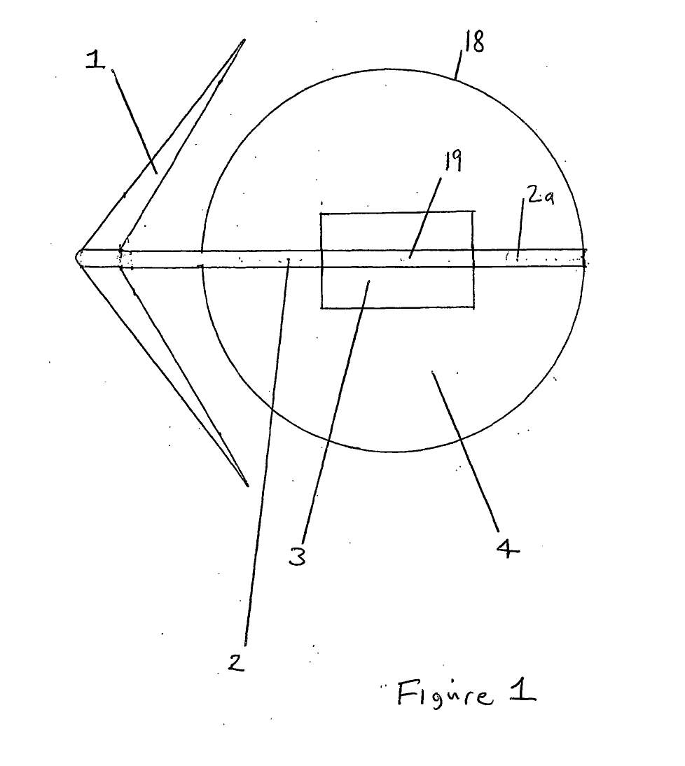

In the first embodiment of the invention the wind can be absorbed by the turbine blade of the wind turbine that generates the electricity which can be large enough to cover the area of the balloon facing the wind. This is shown in FIG. 1 where the turbine blade 1 that revolves as the wind makes contact and generates electricity in the generator 3 as it revolves. The turbine blade also acts to shield the whole of the side of the balloon 18 from the wind and so prevents the wind exerting pressure on the balloon 4 and pushing it out of position or exerting pressure on a cable which may tether it to a fixed position on the ground. The turbine blades of the wind turbine can be of sufficient size to shield all or parts of the balloon or structure filled with lighter than air gas from the wind and the pressure it will exert against the structure which may push the balloon or structure out of the desired position.

In an arrangement not in accordance with the invention the wind energy can be absorbed by a free turning turbine blade that absorbs the wind as it revolves. This is shown in FIG. 6 with the wind absorbing turbine blade 1 connected by the shaft 2 to the structure 4. The freely moving turbine blade or turbine blades can be of sufficient size to shields all or part of one or more sides of the structure from the wind

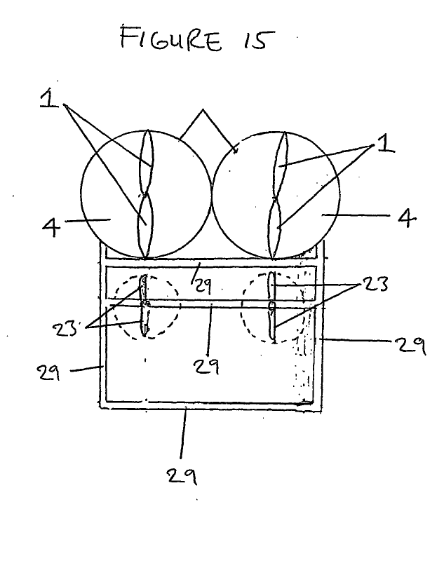

In the third embodiment of the invention the wind can also be absorbed by the balloon or structure filled with a lighter than air gas itself turning as the wind makes contact. This is shown in FIG. 13, FIG. 14a and FIG. 14b. FIG. 14b shows fins 22 that catch the wind. As this happens the whole structure turns in the direction marked by the arrow 21. FIG. 14b shows the inside of the balloon or structure filled with lighter than air gas. As the balloon revolves it generates electricity in the generator 3. The shaft 2a which is a shaft not fixed to turbine blades turns as the structure 4 turns and as it does so this generates electricity in the generator 3.

Another variation of this third embodiment of the invention where the balloon absorbs the wind by revolving as the wind blows is shown in FIG. 13 where the generator hangs below the revolving balloon or structure filled with lighter than air gas. As the balloon 4 revolves it turns the shaft inside the generator 19 and this generates electricity in, the generator 3.

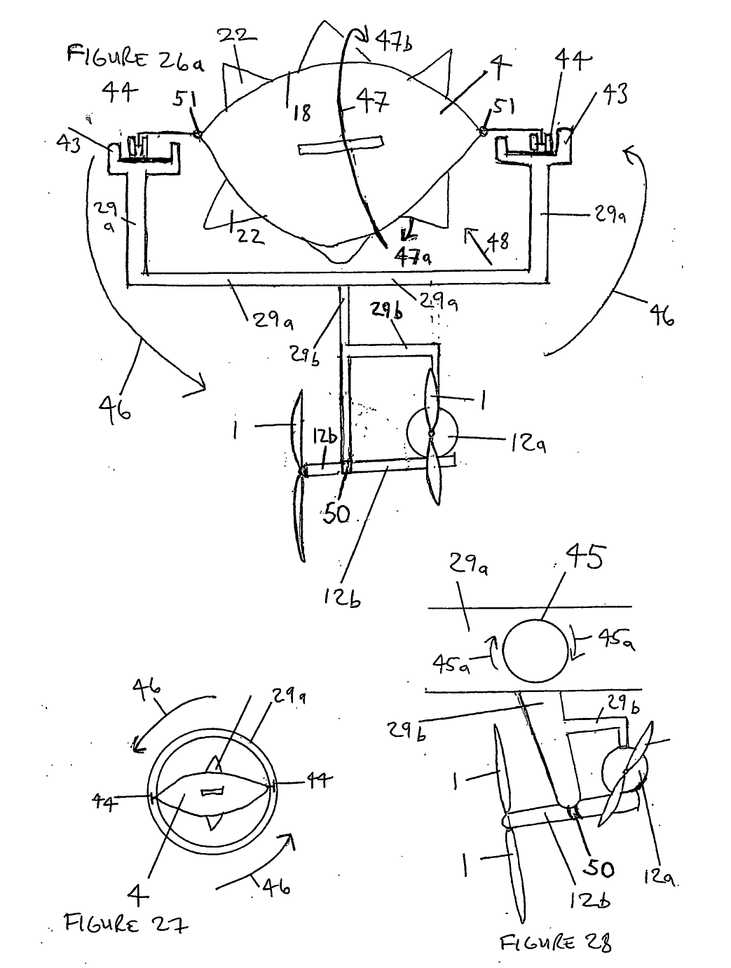

The embodiment or variation of the invention is also shown in FIG. 26, FIG. 27 and FIG. 28. The balloon 4 can turn in different directions, it can roll from bottom to top from 47a to 47b and the whole of the structure 29 connected to the balloon can move in the direction marked by 46. The balloon can also move in other directions. The invention as shown in FIG. 26 is described in more detail later.

The invention allows balloon or structure supporting the wind turbines to be mobile or tethered to a fixed point.

The embodiment of the invention to absorb the wind energy can also be used to propel an airship or a balloon filled with helium or lighter than air gases.

This might not necessarily be to generate electricity but would be a use of this embodiment of the invention to utilise wind energy to provide propulsion for an airship in a way that not only is the wind blowing against the structure of the airship not a problem or a hindrance but it is actually used to provide the energy to move the airship in different directions without having to rely on more conventional power sources to do this. In this embodiment of the invention it is used to brake the turbine blades on one side of a balloon to reduce its resistance to wind and to transfer energy from turbine blades through gears, belts and pulleys this transferred energy can be used to provide forward and sideways propulsion for airship propellers. Hence the power to drive a balloon forwards or in other directions can come from the wind rather than from other energy sources.

Currently there is a search for means of generating electricity from renewable sources such as the wind. This invention is not the actual generator of electricity such as wind turbines but a way of positioning them and keeping them in position, that overcomes environmental problems such as noise made by the machines and their visual impact and the space they take up as well as maximising the amount of electricity generated by allowing the wind turbines to be placed and moved to an area with the highest wind speeds or close to areas needing an electricity supply. The fastest airspeeds are found higher in the sky than at ground level. Different locations in the sky to which the wind turbine can be moved because the invention makes it mobile can offer higher wind speeds than other areas.

A number of examples of the invention will now be described by referring to the accompanying 18 pages of drawings.

In all the drawings the same number will refer to the same feature. The features may be of different shapes or dimensions. The description will refer to different variations of the invention. For example 4 refers to the balloon or structure filled with a lighter than air gas. In some parts of the description the balloon or structure filled with a lighter than air gas it may be referred simply as a balloon.

The invention is about the mounting of a wind turbine. By wind turbine I mean a piece of equipment which includes a generator where the generator marked as 3 in the drawings is turned and produces electricity. The shaft 19 in the drawings within the generator rotates as the turbine blades 1 of the wind turbine rotate as the wind makes contact. The wind turns one or more propellers which turn a shaft 2 which generates electricity in a generator. The shaft 2 is fixed rigidly to the turbine blades 1 at the point that the shaft has contact with the turbine blades.

The generator is described as 3.

The balloon or structure filled with lighter than air gases is described as 4.

The cable or cables holding the balloon to the ground are described as 5.

The cable passing the electricity generated to the ground or national grid are described as 5a.

The winch can extend or shorten 5 is described as 6.

The fins to stabilise the balloon are described as 7.

The wings to stabilise the balloon are described as 8.

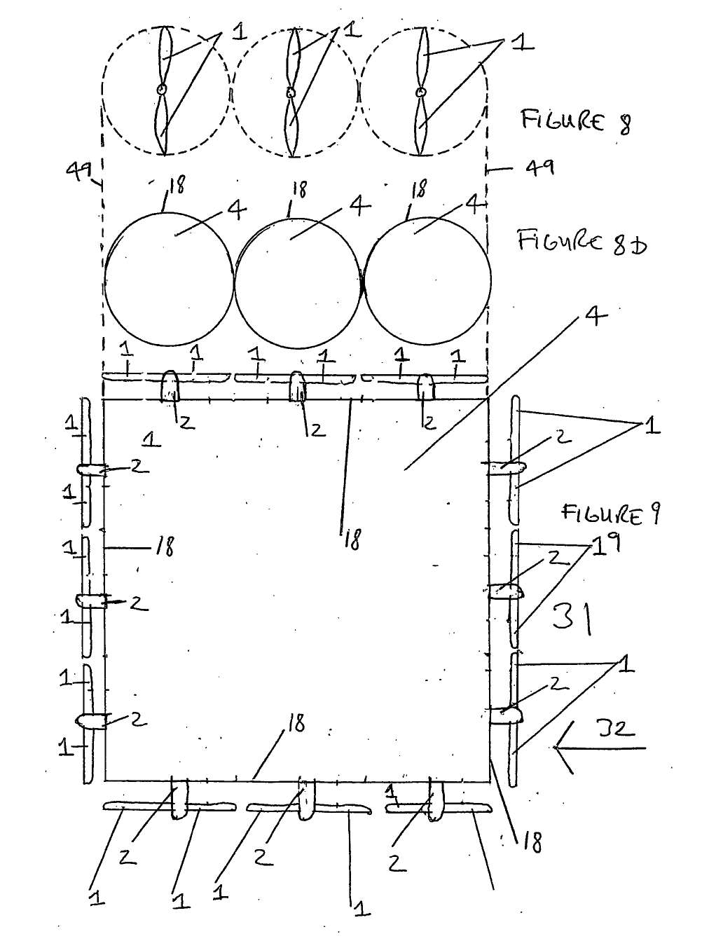

In FIG. 7, which shows an arrangement not in accordance with the invention, the part of the structure connecting the balloon 4 to the generator 3 is described as 9.

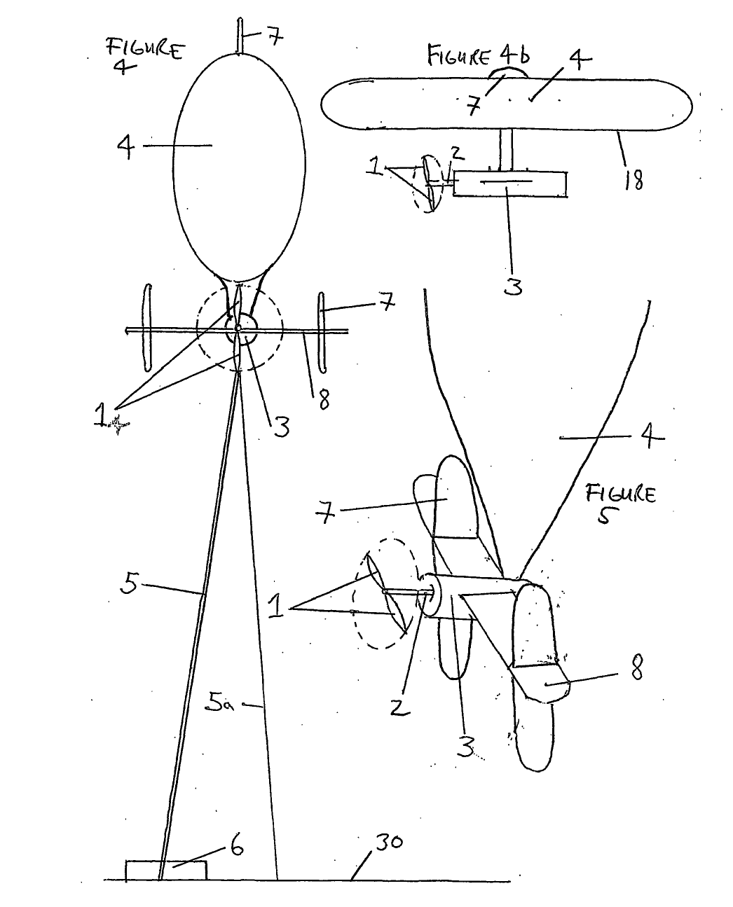

In the arrangement not in accordance with the invention shown in FIG. 4 the flexible joint that joins the balloon and the wind turbine is described as 10 in FIG. 7.

The direction of the turbine blade 1 as shown by an arrow in FIG. 12 is marked as 11.

In the drawings a circle whose line is broken or dotted is not part of the structure but represents the circular path of the turbine blades 1 or 23 as they rotate.

There are two different types of blades known as 1 and 23. Turbine blades 1 are driven by the wind and propeller 23 moves the balloon forwards. Propeller 23 are one or more propellers that make the balloon move forwards and are powered by wind energy that is obtained by turbine blades 1.

The invention uses gears, pulleys and belts. The types of belt that may be used may include vee belts to transfer power.

The gears are of the worm gear or bevel gear type and can change the direction of the wind energy and the speed of the wind energy as it is transferred to a different part of the balloon or structure.

The gear that is powered by the energy source which is wind is known as the driver gear and in the drawings is described as 12a.

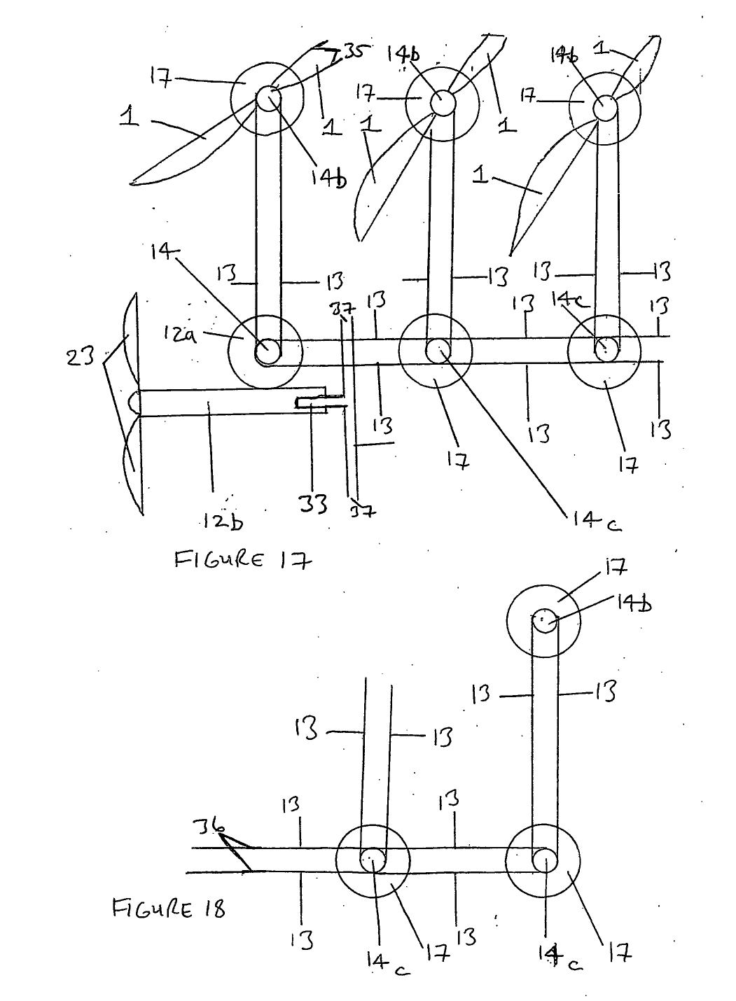

The gear that is connected to the driver gear 12a and which uses the energy passed by the driver gear 12a to power either the generator 3 as shown in FIG. 12 or the propellers 23 to provide forward movement for the balloon or airship as shown in FIG. 16 and FIG. 17, is known as the driven gear and is described as 12b.

The belt which can run for different lengths within the structure is described as 13.

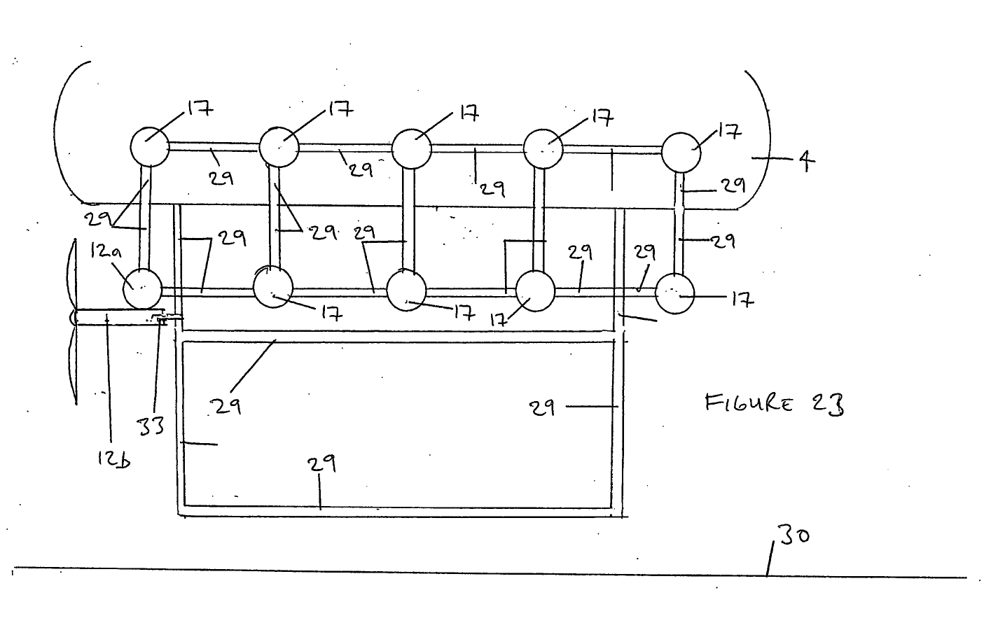

The freely moving pulley fixed rigidly to the driver gear 12a and over which the belt 13 passes is described as 14. Pulley 14 rotates as the belt bringing wind energy from the propellers 1 passes over it. Pulley 14 is fixed rigidly at one end at 40 to the driver gear 12a. As 14 rotates it makes driver gear 12a rotate. This is shown in FIG. 22.

The pulley marked 14b is wrapped around the shaft 2 which moves freely within the structure 17 which supports it but does not hold it rigidly. Neither end of the pulley 14b is fixed.

All the pulleys marked 14, 14b, 14c and 14d rotate on as a belt travels over them. They either receive or pass on energy that has originally come from the wind by way of turbine blades 1. The belt is freely moving over the pulleys.

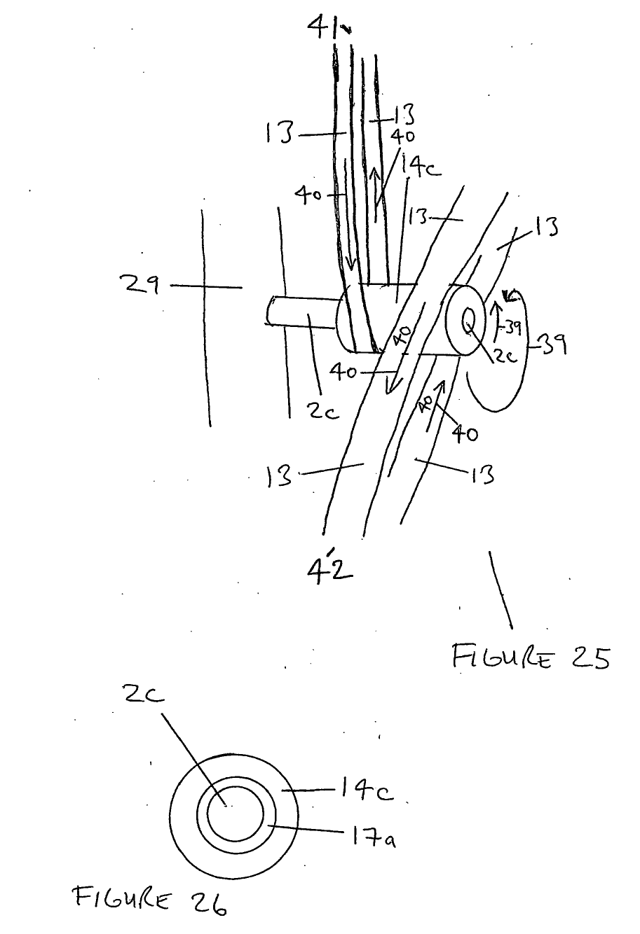

Pulley 14c is shown in FIG. 25 and FIG. 26. Pulley 14c is to hold a moving fan belt that transfers the wind energy to different parts of the structure often at different angles. Pulley 14c is supported but not fixed rigidly to the structure 17.

In FIG. 12 the pulley 14d is of the same design as pulley 14 except that the end which is fixed rigidly is fixed rigidly instead to 19 which is the shaft within the generator. The fixed end of FIG. 14 is fixed rigidly to the driver gear 12a. The reason for the fixed end is to transfer the energy from the belt to either the shaft inside the generator 19 or the driver gear 12a.

The shaft of the turbine blade 1 is described as 2.

In FIG. 12 the shaft 2 fixed rigidly at one end to the turbine blade 1 is fixed rigidly to the driven gear 12a at point 16.

The part of the structure holding pulleys 14, 14b and 14c is described as 17.

The side of the balloon is described as 18.

The part of the shaft within the generator itself whose rotation with regard to the generator actually produces the electricity is described as 19.

The direction of the wind is shown by an arrow is described as 20.

The direction of the revolving balloon as shown in the variation of the invention shown in FIG. 13, FIG. 14a and FIG. 14b is described by an arrow marked as 21.

The curved shaped fin that is turned by the wind in FIG. 13, FIG. 14a and FIG. 14b is described as 22.

The propellers to drive the balloon or airship forwards as shown in FIG. 16 and FIG. 17 and is given the energy to do so by the driven gear 12b are described as 23.

The sails to provide additional energy to move the balloon forwards as shown in FIG. 16 are described as 24.

The rigging to hold and control the sails 24 as shown in FIG. 16 are described as 25.

The cable which can be used to raise or lower the compartment 28 is described as 27.

The compartment holding the crew, passengers, cargo and equipment to control the balloon is described as 28.

In FIG. 16 The framework of the balloon holding the different parts of the craft including the sails 24 and turbine blades 1 and connected to parts of the structure including the part of the structure 17 holding pulleys 14, 14b and 14c is described as 29.

The ground is described as 30.

In FIG. 9 the direction the balloon moves away from the side of the balloon marked 31 is shown by an arrow described as 32. The balloon will move in the direction indicated by 32 when the rotation of the turbine blades 1 on the side marked 31 are slowed so that they absorb less of the wind energy and therefore the wind exerts pressure on that side of the balloon.

In the FIG. 17 the part of the frame 29 of the balloon that fits in the driven gear 12b to support it and also so that it can rotate and which allows 12b to freely rotate is described as 33.

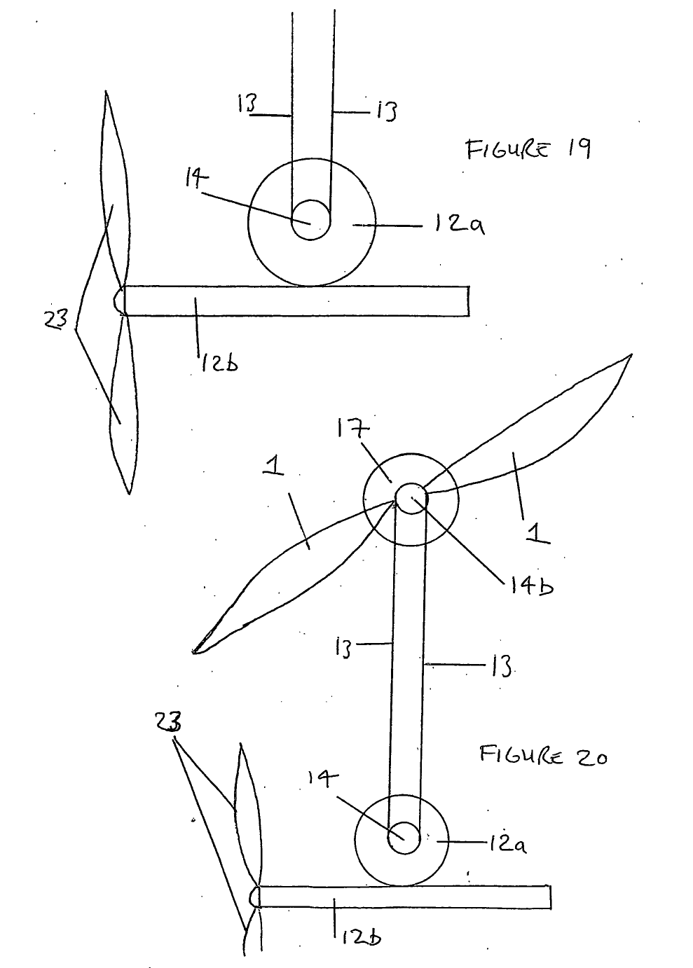

In FIG. 17 the whole of the turbine blade 1 is not shown and this is indicated by 35. Similarly in FIG. 18 not all of the fan belt is shown and where it continues is indicated by 36. To simplify matters the drawings with the invention show parts of the invention and to indicate that the part of the invention continues beyond a particular drawing is indicated by 37. Looking at all the drawings should help describe the invention.

The turbine blade or turbine blades will be described as 1.

The shaft of the wind turbine connected at one end to the propellers will be referred to as 2

The wind turbine works by turbine blades driven by wind turning a shaft in a generator to generate electricity. In the invention the turbine blade is 1, the shaft 2 of the wind turbine which is fixed rigidly to the turbine blades. The generator that produces the electricity is marked as 3. The part of the shaft inside the generator is marked as 19.

The wind turbine is mounted on a balloon to benefit from higher wind speeds and to lessen problems such as noise and other ways wind turbines affect the environment.

In each drawing the same number will refer to the same part of the invention. For example in each drawing 4 refers to a balloon or structure filled with a lighter than air gas. The dimensions and shape of 4 will vary in different drawings.

FIG. 1 shows a cross section of a wind turbine with parts 1, 2 and 3 mounted on a balloon 4 showing the generator 3 inside the balloon.

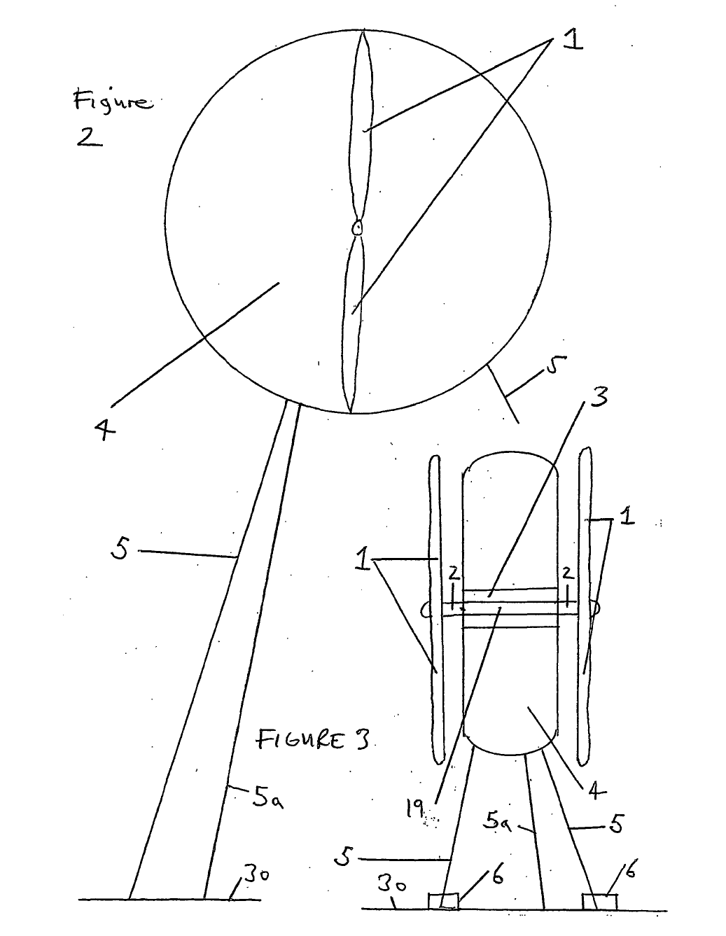

FIG. 2 shows the front of a wind turbine and its turbine blades 1 mounted on a balloon 4.

FIG. 3 shows a cross section of a wind turbine mounted on a balloon 4 with propellers 1 at the front and back of the balloon 4. It also shows how it is tethered along cables 5 to the ground at points 6. The electricity generated would be passed to the national grid along power cables 5a.

FIG. 4 shows the front of an arrangement, which is not in accordance with the present invention, where the wind turbine and the blades 1 and generator 3 is carried underneath the balloon 4

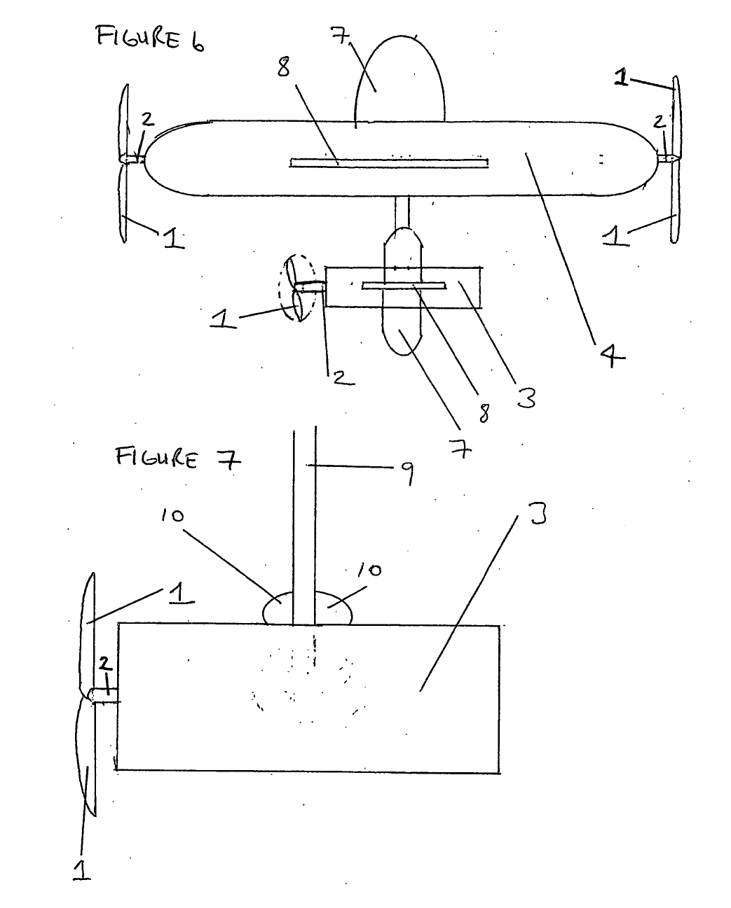

FIG. 5 shows the wind turbine and stabilizing wings and fins of the arrangement shown in FIG. 4

FIG. 6 shows the side of the arrangement shown in FIG. 4 where the wind turbine is carried underneath the balloon.

FIG. 7 shows the flexible joint 10, of the arrangement shown in FIG. 4, holding the wind turbine carried underneath the balloon.

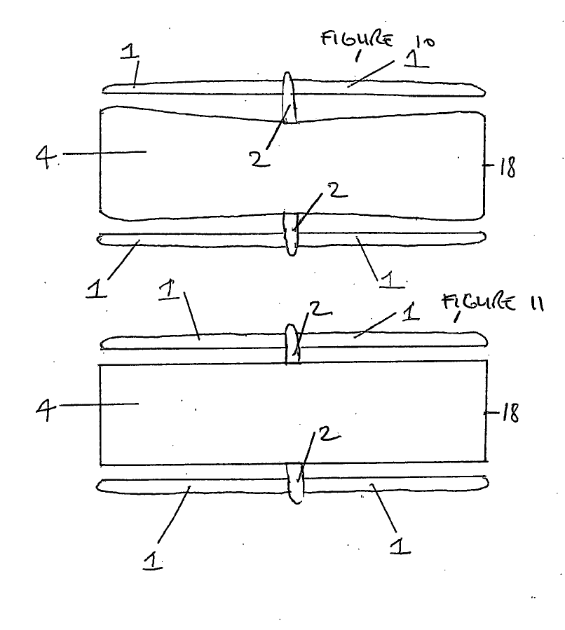

FIG. 8 shows the front of the invention and the turbine blades 1 of the wind turbine

FIG. 8b shows the balloon 4 behind the turbine blades 1 of FIG. 8

FIG. 9 shows turbine blades 1 on all sides of a balloon 4 and shows the shaft of the wind turbine 2.

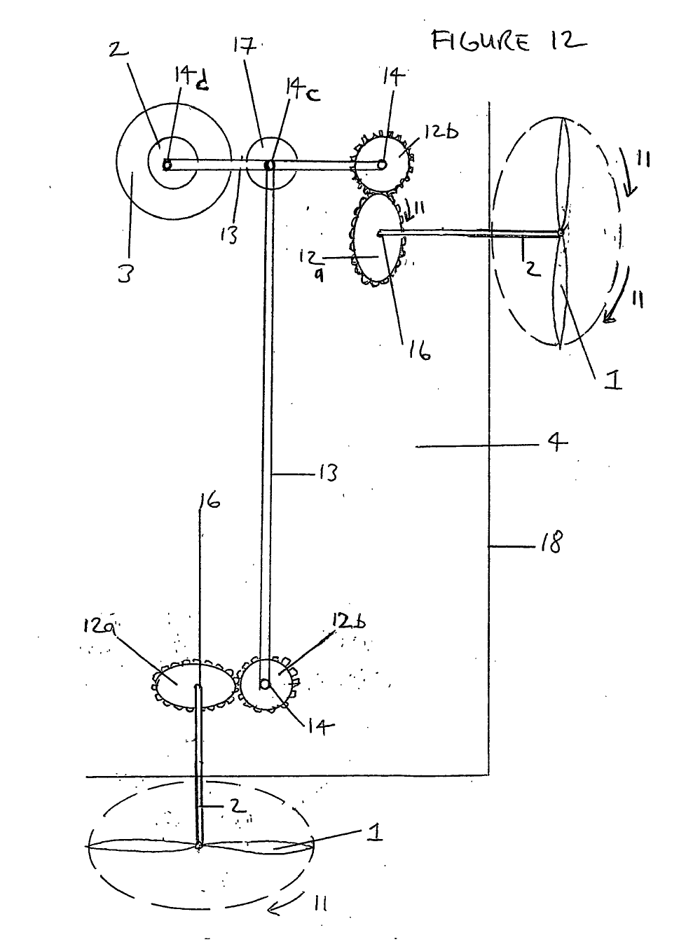

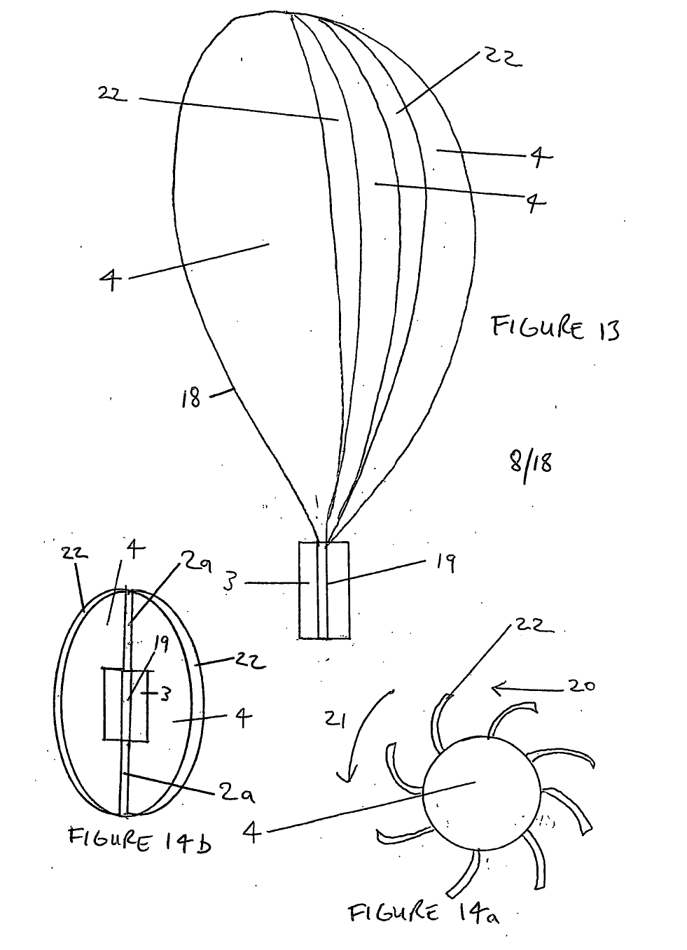

FIG. 10 and FIG. 11 show a side view of the balloon 4 with turbine blades 1 mounted above and below the balloon 4.

FIG. 12 shows the system using gears, pulleys and fan belts in a variation of the design where there are a number of turbine blades 1 on different positions on the balloon 4. In this variation of the invention the energy produced by the turbine blades driven by the wind can be transferred in different directions to drive one generator 3 to reduce the weight of the structure.

FIG. 13 shows a variation of the invention without turbine blades where the balloon 4 itself is turned by the wind when the wind makes contact with fins 22 and this rotation makes the shaft 19 within the generator 3 rotate and this generates electricity. In this variation of the invention the generator 3 which hangs below the balloon 4.

FIG. 14 shows a view from overhead of the variation of the invention in FIG. 13 where the balloon is turned by the wind as it makes contact with the curved fins 22 that are driven by the wind 20 to make the balloon rotate in the direction marked by the arrow 21.

In FIG. 14b the generator 3 and the shaft 19 that rotates inside the generator are located inside the balloon 4.

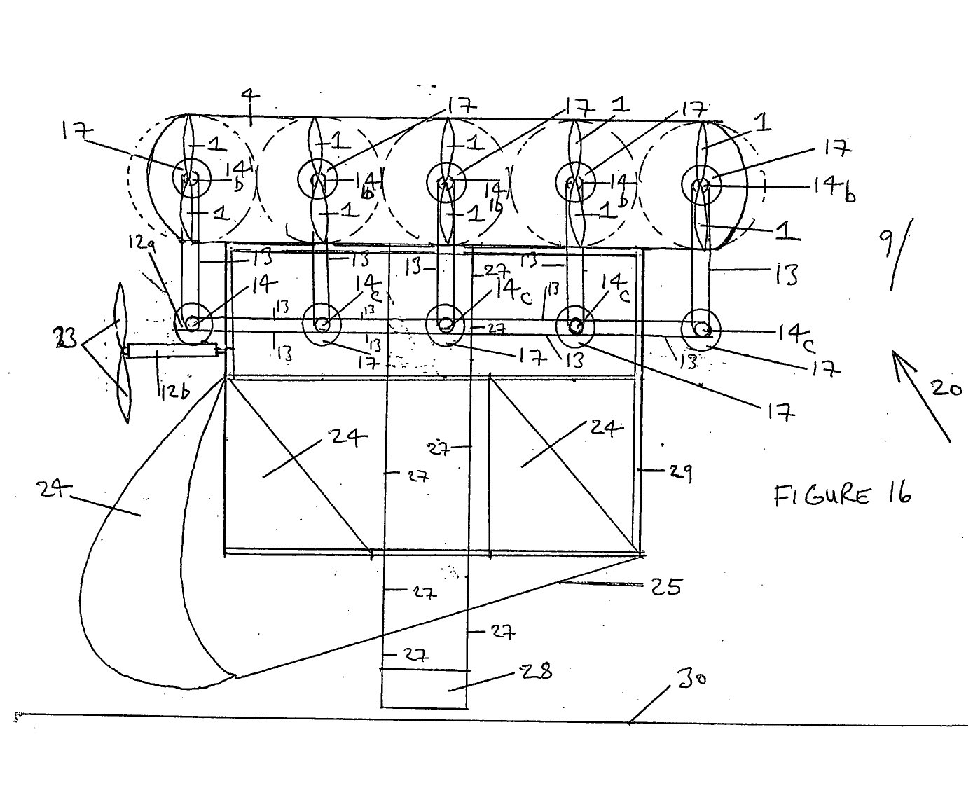

FIG. 15 shows the front of a variation of the invention also shown in FIG. 16 where the use of turbine blades 1 to absorb wind energy and gears, pulleys and fan belts as shown in FIG. 12 to move this energy from the wind around a structure can be used to drive propellers 23 to drive a balloon forwards.

FIG. 16 shows a side view of a balloon where wind energy is absorbed on the sides by turbine blades 1 and transferred to propellers 23 to drive the balloon forwards. Forward movement is assisted by sails 24 held in position by the framework 29 of the structure below the balloon with a sail in the front controlled by rigging 25. The compartment 28 containing the crew, controls to the balloon, the passengers and cargo can be lowered to the ground by a cable 27 so that the balloon does not have to descend.

FIG. 17 shows in more detail the part of FIG. 16 and the propellers 23 connected to the driven gear 12b which is driven by the driver gear 12a which receives its energy from a fan belt 13 that runs over pulleys 14 and 14b and which is driven by the energy that the turbine blades 1 obtain as the wind 20 in FIG. 16 makes contact. The pulley 14c allows the energy to be transferred from other turbine blades along the side of the balloon. The pulley 14c also alters the direction of the energy travelling from the turbine blades 1 to drive the driver gear 12a.

FIG. 18 shows in more detail the fan belt 13 and the pulley 14c. It also has one example of the fan belt from one of the turbine blades which travels over pulley 14b which is supported by part of the structure 17 but which allows the pulley 14b to move freely. That only part of the fan belt 13 is shown and which continues is shown by 36.

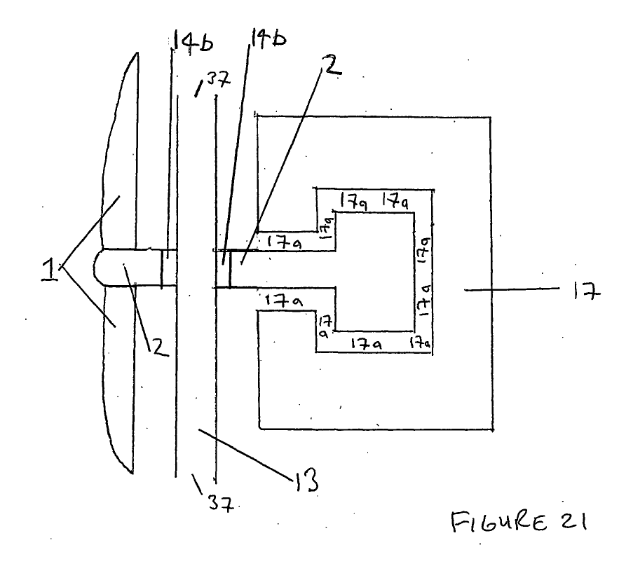

FIG. 19 shows the fan belt 13, the pulley 14 which is fixed rigidly to the driver gear 12a and the driver gear 12a as it rests on the driven gear 12b which rotates and makes the propellers 23 rotate. The propellers 23 are fixed rigidly to the driven gear 12b.

FIG. 20 shows the part of the structure above the part shown in FIG. 19. The turbine blades 1 are shown. These turn as the wind makes contact. The turbine blade 1 and shaft which is not shown are supported but able to move freely by part of the structure described as 17. The pulley 14b is fixed rigidly to the turbine blades 1 and rotates as the turbine blades 1 rotate. This drives a fan belt 13 which turns another pulley 14 which is fixed rigidly to the driver gear 12a which as it is turned by the fan belt 13 turns a driven gear 12b and transfers the energy at 90 degrees. As the driven gear 12b turns so do the propellers 23 which are fixed rigidly to the driven gear 12b.

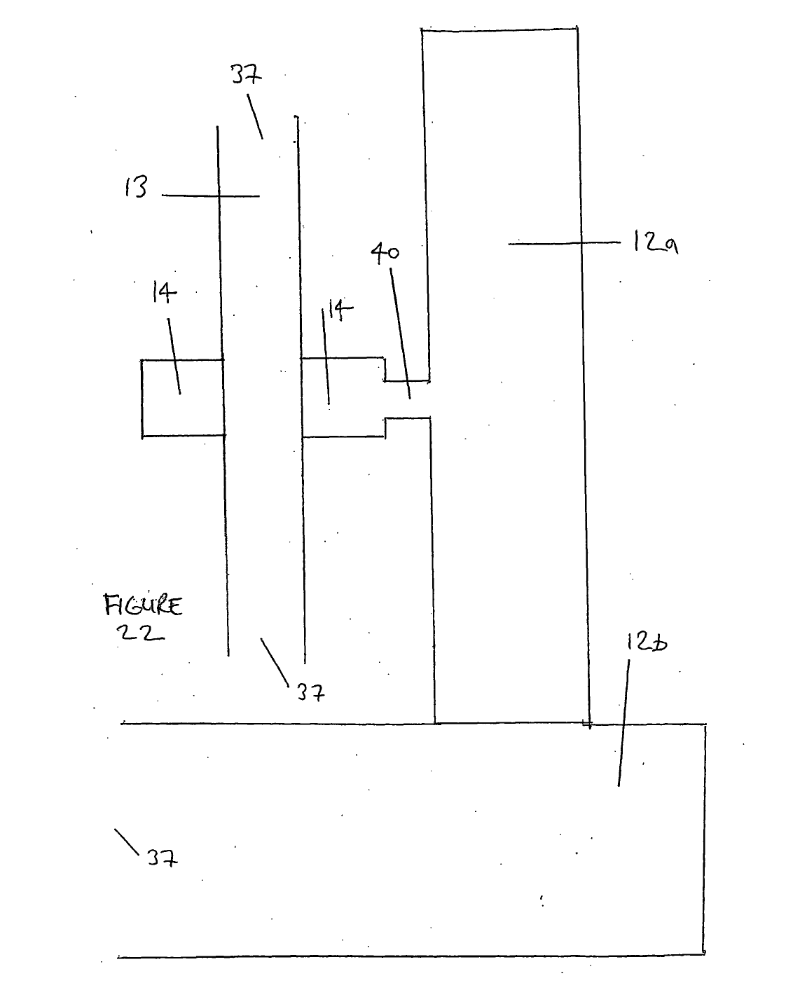

FIG. 21 shows in detail the pulley 14b which is connected rigidly to the shaft 2 which is supported by but moves freely within the part of the structure described as 17. The area of the structure 17 not connected to the shaft 2 and where the shaft 2 can move freely as it is turned by the turbine blades as the wind makes contact with them, is described as 17a. The fan belt 13 moves freely over the pulley 14b. As the pulley 14b rotates this moves the fan belt 13 and the energy is taken by the fan belt to another part of the structure. The transferred energy can then drive a generator 3 as in FIG. 12 or drive propellers 23 to make a balloon move forwards as in FIG. 16 and FIG. 17. The belt continues beyond the drawing as shown by 37.

FIG. 22 shows the pulley 14 fixed rigidly as 40 to the driver gear 12a. The belt 13 moves as it is supplied by energy from the turbine blades 1 and this makes the pulley 14 rotate. As the pulley 14 rotates it turns the driver gear 12a. The driver gear 12a has teeth which are not shown which interconnect with teeth on the driven gear 12b. As the driver gear 12a rotates it turns the Driven gear 12b. The energy changes direction by 90 degrees.

FIG. 23 shows a side view of the framework 29 of the airship shown in more detail in FIG. 16. The framework 29 connects parts of the structure 17 which support pulleys 14, pulley 14b and pulley 14c and connect them with the balloon 4.

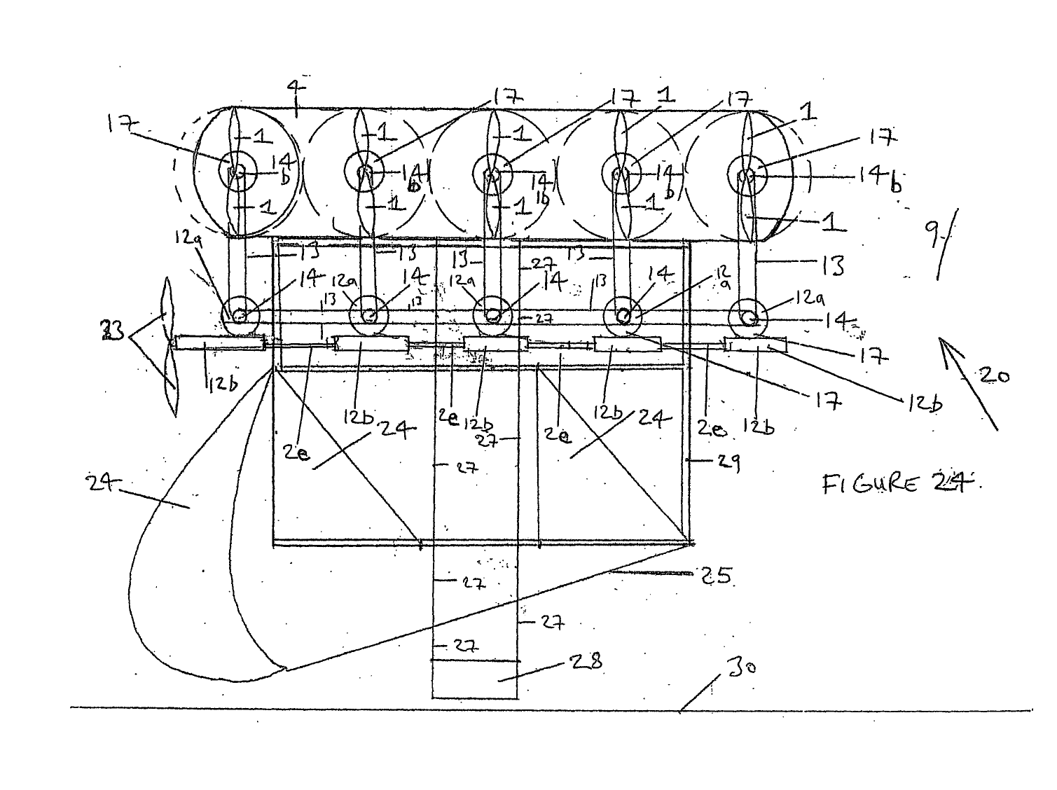

FIG. 24 shows a variation of the invention as applied to an airship where the wind energy is transferred more directly from driver gears 12a to driven gears 12b.

FIG. 25 and FIG. 26 show pulley 14c.

FIG. 26a, FIG. 27 and FIG. 28 show a variation of the invention where the balloon itself rotates and turns sideways to absorb wind energy.

The invention is a wind turbine which is mounted on a balloon or structure filled with a lighter than air gas which enables the wind turbine to be driven by higher wind speeds found at higher altitudes.

The invention consists of one or more wind turbines placed along one or more of the sides of a balloon as in FIGS. 1, 2, 3, 8, 8b, 9, 10, 11 and 16.

The invention in its simplest form is shown in FIG. 1. The generator 3 is situated in this variation in the centre of the balloon. The winds which are stronger in the sky blow against the turbine blade which are marked as 1. The propellers rotate and simultaneously turn a shaft 2 which is fixed rigidly to the turbine blades 1. The turbine blades 1 can be large enough to shield all or part of the balloon or structure behind it from the wind. The part of the shaft situated within the generator is marked as 19. This is a continuation of the shaft 2. The shaft 19 rotates and as it does so electricity is produced. In this variation part of the shaft marked as 2a extends from the end of the generator to the side of the balloon. This is to help provide balance for the weight of the propellers. The generator would also be placed to balance the weight of the propellers. The balloon itself is marked as 4. This mounting of the balloon would be tethered to the ground using cables.

FIG. 2 shows the balloon carrying the wind turbine as it is seen from the front. It is tethered to the ground using cables marked as 5 and the electricity is carried to the ground using cables marked as 5a. The ground as in other drawings is marked as 30.

In FIG. 3 there is a variation of the invention with propellers at both sides. This drawing also shows the winches 6 which can extend or shorten the cables 5 to change the altitude of the balloon.

An arrangement not in accordance with the invention is shown in FIG. 4, FIG. 4b, FIG. 5 and FIG. 6 where the wind turbine is carried below a balloon or structure filled with lighter than air gasses.

The balloon carries the wind turbine rather than having it located internally. Essentially it is the same as mounting a wind turbine on a balloon. The generator 3 is stabilised by fins 7 and wings 8. This is seen in more detail in FIG. 5. The wind turns the turbine blade 1. This is connected to a shaft that generates electricity. One advantage of this might be that the turbine could be lowered to the ground for maintenance while the balloon remains airborne in the same way that is later described for the airship application of this invention that is shown in FIG. 16 the airship compartment 28 can be lowered to the ground using cables 27.

The side view of the arrangement shown in FIG. 4 and FIG. 5 is shown in FIG. 4b and in more detail in FIG. 6. FIG. 6 shows two turbine blades 1 at the front and back of the balloon 4. These turbine blades might be to absorb the wind energy so that it doesn't apply pressure against the structure. In this case the propellers 1 would be free turning and would turn as fast as the wind blowing against them. Because they turned the wind energy would be absorbed and would not push the balloon out of position.

FIG. 7 shows a feature of the wind turbine of the arrangement shown in FIG. 4. The feature marked 9 represents the part of the structure connecting the balloon to the wind turbine. The feature marked 10 in this drawing represents a flexible joint that holds the wind turbine and can absorb the effect of the buffeting of the wind on the wind turbine and the movement and vibrations it may cause. If the connection was rigid it might lead to metal fatigue.

Another variation or embodiment of the invention is shown in FIG. 13 and FIG. 13 where the balloon or structure filled with lighter than air gasses revolves as wind strikes curved shaped fins 22 and drives a generator 3 and 19 which does not revolve.

In the embodiment of the invention shown in FIGS. 1, 2, 3, 8, 8b, 9, 10, 11 and 16 the turbine blade or turbine blades of the wind turbine should reach to the top of the side. The propellers absorb the wind energy and this stops the wind pushing the balloon out of the desired position. Wherever there are turbine blades for example on the other sides it absorbs wind energy and stops any wind pressure against that particular side.

If it is desired to move the balloon in any direction the turbine blades on one side for example on one of the sides 31 in FIG. 9 can have a brake applied so that their rotation slows down. This has the effect of reducing the amount of wind energy that is absorbed by the turbine blade of the wind turbine on that side. Therefore the wind on this side will not be fully absorbed by the propeller and will therefore apply pressure to that side and the balloon will be pushed in the direction of the arrow 32.

On the same page 5/18 that shows FIG. 9 there are also FIG. 8 and FIG. 8b. FIG. 8 shows the turbine blades 1 and their path of rotation that would take place for FIG. 9. This variation has three balloons 4 connected to each other. This provides the platform for the wind turbines. The invention can consist of different sizes and shapes of balloon to carry the wind turbine. The dotted line marked as 49 shows the edge of the rotation of the turbine blade 1 of the balloon on the outside which is seen as a view from the front that corresponds with the edge of the balloons 4 on the outside that would carry it which is also seen as a view from the front as it would appear without the turbine blades attached and the edge 18 of the invention shown in FIG. 9 which shows a view of the structure from above.

FIG. 10 and FIG. 11 show the embodiment of the invention with turbine blades 1 at the top and bottom of the balloon 4 which are free moving not to generate electricity but to rotate to absorb the wind energy so that the wind doesn't push the balloon downwards or upwards. For example if wind blew from above the balloon it would be absorbed by the rotation of the turbine blade 1.

The wind turbine would be designed to be as light as possible. The actual generator to produce the electricity would be positioned to balance the structure. The balloon might be designed to be as light as possible. Other designs might envisage one wind turbine rather than many with the balloon designed to trap as much wind energy as possible and direct it to one turbine only.

Another way to reduce the weight of the turbine in proportion to the weight of the balloon, would be to have a system with many turbine blades catching the available wind power and directing it through a series of moving belts to drive one generator rather than many as shown in FIG. 12.

The invention uses the technology of gears known as worm gears and bevel gears to transfer energy around the structure in different directions as much as 90 degrees. The invention uses worm gears to transfer wind energy that is obtained from turbine blades 1 to propellers 23 as shown in FIG. 16 and FIG. 17 and this changes the direction the balloon or structure moves and can change the speed with which it can move.

The gear which is connected to the power source, which are the turbine blades 1 and are connected either directly or indirectly to the turbine blades 1 which are turned by wind energy is known as the driver gear. The gear or wheel which uses this energy to either drive an electricity generator 3 as in FIG. 12 or propellers 23 to make a balloon move forwards as shown in FIG. 16 is known as the driven gear.

In all the drawings to illustrate my invention the driver gear is marked as 12a and the driven gear is marked as 12b. The same invention is shown in this description to drive a generator 3 to produce electricity or propellers 23 to make a balloon or airship move forwards. The same invention is at work. The power source is the wind which drives turbine blades 1

This energy can then be transferred around a structure using pulleys marked 14, 14b and 14c. The drawing that shows the invention driving a generator in FIG. 12 has a pulley 12d that is connected to the shaft of the generator itself.

In all the drawings the pulley 14 is fixed rigidly to the driver gear 12a and the pulley marked 14b is made to rotate by shaft 2 which moves freely within the structure 17 which supports it but does not hold it rigidly. It moves freely at the points and in the area marked 17a. This is shown in FIG. 21. The area marked as 17a may contain features such as ball bearings to allow fast free movement of the shaft 2 within 17.

All the pulleys which are marked in the drawings as 14, 14b, 14c and 14d make a belt pass over it as they rotate. The belt 13 is freely moving over the pulleys. The pulleys vary as shown in FIG. 21, FIG. 22 and FIG. 25.

The pulley marked 14c is to hold a moving fan belt that transfers the wind energy to different parts of the structure often at different angles. 14c is supported but not fixed rigidly to the structure 17.

FIG. 12 shows two turbine blades 1. There may be more turbine blades in a variation of the invention. As the wind makes contact with the turbine blade 1 it rotates in the direction indicated by the arrow marked 11. The turbine blade 1 is fixed rigidly to a shaft marked as 2. As the turbine blade 1 is turned by the wind it turns the shaft 2.

The shaft 2 14 is fixed rigidly to 15. The shaft 2 is fixed rigidly at the point marked 16 to a driver gear marked 12a. This driver gear 12a has teeth that make contact with the teeth of the driven gear 12b to transfer the energy to another direction. As the driver gear 12a is turned by the shaft 2 connected to the propeller 1 it connects with through its own teeth with the teeth of the driven gear 12b and therefore the driven gear 12b also rotates. The driven gear 12b holds pulley 14 over which runs a fan belt 13. The design of pulley 14 is shown in more detail in FIG. 22 which shows it connected rigidly to a driver gear 12a as applicable to make an airship move forwards as shown as a whole in FIG. 16. Essentially pulley 14 needs to be fixed rigidly at one end to the gear that is being made to rotate.

In FIG. 12 pulley 14 is fixed rigidly to a driven gear marked as 12b. The working of pulley 14 in FIG. 12 is as shown in FIG. 22 except in place of being fixed rigidly to a driver gear 12a as shown in FIG. 12 it is fixed rigidly to a driven gear 12b.

In FIG. 12 as the driven gear 12b turns so does the belt 13 which can be of different lengths within the structure. The energy is transferred within the structure by a moving belt.

At the other end of the belt the moving belt moves over a pulley 14c which is shown in more detail in FIG. 25 and FIG. 26.

Looking at FIG. 25 the pulley is fixed rigidly to the frame of the whole structure marked as 29. The pulley itself rotates freely on a shaft marked as 2c. One belt moves towards a point marked as 42. This causes the pulley 1c to rotate. As it pulley 14c rotates it makes another belt also move. In the drawing in FIG. 25 cause the second belt is seen to be moving away from a point marked as 41 at right angles to the first belt. Thus the energy is transferred to a different direction. The energy can be made to change direction at different degrees. In FIG. 25 the direction of the moving belts is shown by arrows marked as 40. FIG. 26 shows a cross section of the pulley 14c with the pulley itself wrapped around in a continuous circle a shaft marked as 2c with an area to allow free movement between two moving parts marked as 17a.

Returning to FIG. 12 the wind energy has therefore completed its journey within the structure. The second fan belt turns on a pulley marked as 14d. The pulley 14d is the same as 14 which is shown in FIG. 22 except that whereas in the drawing 14 is fixed rigidly to a driver gear 12a in this case pulley 14d is fixed rigidly at one end to the part of the shaft 19 that is inside the generator 3. Earlier 14 was demonstrated using the same FIG. 12 but where it was fixed rigidly to a driven gear 12b as shown in FIG. 12 rather than a driver gear 12a as shown in FIG. 22.

Finally as shown in FIG. 12 as the moving belt 13 makes the pulley 14c rotate and the end of pulley 14c is fixed rigidly to the shaft of the generator 19 which is inside the generator 3 the shaft 19 turns and electricity is generated. The actual shaft 19 is not shown in FIG. 12 but is can be seen in other drawings such as FIG. 1 and FIG. 14b.

In this way the energy from the wind can be transferred from the turbine blades on the side or sides of the balloon and this energy can then be transferred in different directions even at right angles to the revolving shaft 19 which turns and generates electricity within a single generator 3. Thus the weight of the entire structure is reduced.

The edge of the balloon is shown by 18.

So that with the invention the structure can have one generator rather than several. Normally conventional designs of wind turbines on the ground the generator is set behind the turbine blade so that as the shaft that is turned by the turbine blade the shaft directly turns the generator. The invention uses gears, fan belts and pulleys to overcome the problem that having turbine blades on different sides of the structure would normally require a similar number of generators in fixed positions in relation to the turbine blades adding to the weight of the structure.

The generator might be situated in any part of the structure. The turbine blades would be rotated by the wind. The rotating turbine blades 1 would drive fan belts 13 as in FIG. 12. The moving fan belts 13 could move the energy to other fan belts 12 running at right angles to the fan belts attached to the turbine blades to turn the generator to produce electricity.

In another embodiment of the invention the balloon itself can be designed to be propelled by wind as in FIG. 13 and FIG. 14a and in this variation of the invention the balloon itself can drive the generator 3 which can be situated below the balloon as in FIG. 13 or within the balloon as in FIG. 14b.

In this embodiment of the invention where the balloon itself driven by the wind turns the generator rather than the generator been turned by turbine blades mounted on a balloon. In this variation of the invention shown in FIG. 13 the balloon would have fins 22 that would extend from the bottom to the top and the balloon. The wind would make the whole balloon turn in a circular direction and this would turn the shaft 19 within the generator 3 to produce electricity.

The height of the balloon can be adjusted and the relative air pressures caused by factors such as air temperature compensated for by using some of the electricity generated to heat elements within the balloon to make the helium or inert gas expand within the balloon to make the balloon gain altitude. To allow the balloon to descend the electricity to these elements would be turned off to allow them to cool and for the gasses within the balloon to contract and therefore for the balloon to lose altitude. The heating elements could be used to make the gas in the balloon lighter by warming it to adjust for atmospheric conditions when the pressure of the air might vary.

The electricity would be transferred to the national grid by cables than would be lowered once the balloon was in position and would hang down from the balloon and would transmit the electricity to the nearest part of the grid. This is shown in FIG. 2 and FIG. 3. The cables holding the balloon in position in this variation of the invention are marked as 5. The winch 6 to extend or shorten the cables 5 are marked as 6 and the cable passing the electricity generated to the national grid is marked as 5a. Alternatively the electricity would be beamed to the national grid by microwaves as this technology developed.

Further to the previously mentioned invention to reduce the part of the structure generating the electricity by using one generator rather than several and achieving this by having a system with many turbine blades catching the available wind power on different sides of the balloon and directing it through a series of moving belts to one generator this idea could help drive an airship with wind power as shown in FIG. 16. This use of the invention could drive an airship by transferring the energy of one side of a balloon, where the turbine blades 1 would turn as the wind made contact and would simultaneously absorb the wind's energy, thus preventing the wind pushing the balloon to either side and then would transfer the energy of the wind through a series of belts and pulleys and gears to the front propellers 23 that would drive the balloon forward. In this application of the idea additional forward propulsion could be obtained from sails which are marked as 24 and would work in the same way as sails worked in traditional sailing ships.

The use of the invention to use wind to drive an airship would work using wind energy directed to forward propellers using pulleys and belts to move the energy around the structure in the same way as described earlier for the generator shown in FIG. 12.

The airship is shown in FIG. 15 and FIG. 16. In FIG. 16 wind blowing against the side of the airship is absorbed by turbine blades 1. The turbine blades 1 turn as the wind makes contact with them. This energy is then transferred along fan belts 13 to direct the energy to drive propellers 23 to provide forwards propulsion.

FIG. 21 shows this in more detail. The turbine blades 1 are fixed rigidly to the shaft 2. The other end of the shaft 2 is supported but able to turn freely within the part of the structure 17. As the shaft turns it makes a belt 13 move.

In FIG. 21 the turbine blades 1 are fixed rigidly to a shaft 2. As the wind makes the turbine blades 1 rotate the shaft 2 rotates. At the other end to the turbine blades the shaft 2 is supported by part of the main structure of the craft but is able to move freely. The area which allows free movement between two moving parts is marked as 17a. As the shaft rotate it makes a pulley 14b rotate. Pulley 14b is wrapped around in a continuous circle around the shaft 2 in the same way as another pulley 14c is wrapped around a shaft and which is shown in FIG. 26.

As pulley 14b rotates it makes the belt 13 move over it and therefore the energy from the wind blowing against the turbine blades 1 on the side of the craft is therefore transferred to another part of the structure in this case the ultimate destination of this energy is to drive propellers 23 to make the balloon move forwards. This is rather than to drive a generator to generate electricity as earlier described.

Looking again at FIG. 25 it shows the moving belt 13 travelling from point 41 which is the area of the turbine blades 1 and as it passes over pulley 14c it makes pulley 14c rotate. As the pulley 14c rotates it makes a second belt move towards point 42 which is the area of the propellers 23 which are made to rotate as the energy is transferred first to the driver gear 12a as shown in FIG. 17 which then passes the energy at 90 degrees to the driven gear 12b also shown in FIG. 16.

This process is shown in more detail in FIG. 19 and FIG. 20. FIG. 19 shows the belt 13 which is transferring wind energy from the turbine blades not shown in this drawing to drive a pulley 14 which is fixed rigidly to a driver gear 12a, a process which is shown in more detail in FIG. 12. As the belt makes pulley 14 turn it makes the driver gear 12a turn. The teeth of driver gear 12a interconnect with the teeth of driven gear 12b which also turns. As the driven gear 12b turns it makes the propellers 23 which are fixed rigidly to the driven gear 12b rotate and the balloon moves forwards.

FIG. 20 shows the position of the turbine blades 1 relative to the driver gear 12a, driven gear 12b and the propellers 23 to make the balloon move forwards.

The invention as it applies to making a balloon move forwards using wind power is shown in FIG. 17 and FIG. 18. These drawings show the process and include a feature 33 where the driven gear 12b is connected and supported to the craft but where the driven gear can rotate freely. The area marked 36 in FIG. 18 indicates only part of the fan belt is shown and 37 indicates that the feature shown continues beyond the drawing. In most of the drawings the features will continue beyond what is shown but the drawings taken as a whole should help describe the invention.

In FIG. 17 the driver gear 12a rotates forwards. The teeth of driver gear 12a connect with and make driven gear 12b rotate sideways. As driven gear 12b rotate sideways and it can rotate freely on part of the structure 33 shown in FIG. 23 which is a shaft connected to the frame of the whole structure 29. As the driven gear 12b rotate sideways they make the propellers 23 which are fixed rigidly to them also rotate and as they do this makes the balloon move forwards. The direction of the moving belts 13 are shown by an arrow 40.

Returning to FIG. 25 the direction of the rotation of the pulley 14c is shown by a circular arrow 39.

The pulley 14c turns freely on a shaft 2c which is fixed rigidly to the frame of the structure 29. FIG. 26 shows a cross section of the pulley 14c which is able to turn freely because of an area 17a. The pulley 14c and the shaft 2c are not fixed to each other. Free movement might be assisted by ball bearings in the area 17c.

An embodiment of the invention as applied to driving an airship using wind power is shown in FIG. 24. In this variation instead of the energy being transferred by pulleys 14c as in FIG. 16 and FIG. 17 the invention shown in FIG. 24 could be modified so that the belt 13 driven by the turbine blades 1 connected to the pulley 14 carrying the belt would transfer the energy directly to driver gears 12a, one for each set of turbine blades 1. The driver gear 12a would then turn and transfer the energy at 90 degrees directly to a driven gear 12b. A series of driven gears 12b would be connected by a shaft 2a and they would turn together to make the propellers 23 rotate and make the balloon go forwards.

To allow the airship to move in different directions the turbine blades on one side can have a brake applied so that their rotation slows and allows wind pressure on the side of the turbine blades revolving more slowly to apply pressure as described earlier for FIG. 9.

To simplify the description and demonstrate the same method of using gears, pulleys and belts are at work to redirect wind energy to drive an airship as described earlier to drive a generator shown in FIG. 12 to save weight and can be used to drive propellers 23 in FIG. 16 the same numbers including 12a to show the driven gear that is connected to the source of the energy perhaps via a pulley 14c and the driven gear 12b that uses the energy to either turn a generator 3 in FIG. 12 or propellers 23 to make a balloon move forwards as is shown in FIG. 16.

In the case of FIG. 12 the invention is to drive a wind generator 3 and in FIG. 16 the invention is to drive propellers 23 to provide forwards movement. The application of the invention in FIG. 16 in provides the same flexibility to move energy around the airship as to generate electricity as in FIG. 12.

As shown in FIG. 21 where the power is provided by the turbine blades 1 which rotate when the wind makes contact the pulley 14b is fixed rigidly to the turbine blade 1 and the shaft 2. This is shown in detail in FIG. 21. As the wind makes contact with the turbine blades 1 they make the shaft 2 which is fixed rigidly to 1 also rotate. As the shaft 2 rotates it makes the pulley 14b spin. Pulley 14b has the shaft 2 passing through its centre. The revolving pulley 14b makes the belt 12 move across it and this takes the wind energy to another part of the structure. The shaft 2 is not fixed rigidly to the structure 17 but turns freely. The part of the drawing marked 17a shows where the structure is designed to allow the shaft 2 to turn freely within the structure 17 which supports but does not hold the shaft 2 rigidly

Where the wind energy is transferred using pulleys within the structure and uses pulleys to change direction the pulley that carries out this task is marked as 14c and this is shown in FIG. 16 and FIG. 17. Pulley 14c is supported but not fixed rigidly to the structure 17.

FIG. 24 shows the areas of the structure marked 17 and the frame of the balloon or structure marked 29 without showing the fan belt or pulleys 14, 14b and 14c.

Where the wind energy is used to drive the propellers 23 the pulley driven by the fan belt with energy from the turbine blades 1 is fixed rigidly to the driven gear 12b. This is shown in FIG. 22.

An embodiment of the invention as used in powering an airship would be to allow the balloon itself to rotate in different directions to absorb the wind energy against its sides rather than the energy be absorbed by turbine blades 1 as in FIG. 17. This is shown in FIG. 26a. The invention of a rotating balloon would use the same inventive idea as seen in FIG. 13, FIG. 14a and FIG. 14b where a rotating balloon itself to directly generate electricity rather than supporting turbine blades that would drive the shaft 2 and hence the generator 3. In this case a variation of this inventive idea would use the rotating balloon to reduce wind resistance against the balloon where the wind would otherwise apply pressure against the structure and make the balloon move.

This is also the embodiment of the invention as used for an airship is shown in FIG. 26a, FIG. 27 and FIG. 28.

FIG. 28 shows a balloon which can rotate sideways or from the bottom to the top or top to bottom and therefore absorb the wind energy that would otherwise distort its flight path. The balloon in turn supports two propellers 1 which are set at right angles. These propellers 1 can change speed to make the balloon move in different directions.

The propellers 1 work by worm gears with a driver gear 12a and a driven gear 12b. They can work in reverse to change direction. As shown in FIG. 28 to accommodate the movement of the balloon sideways movement the entire frame 29a of the structure can rotate. The top of the frame 29a would be circular.

In FIG. 26a the arrow marked 46 suggests how the top part of the structure holding the balloon marked as 29a would turn from left to right if the wind came from the left of the structure.

If the wind came from another direction as indicated by the arrow marked as 48 the balloon would rotate from bottom to top, basically in a rolling motion as shown by the arrow 47 from the point marked as 47a to the point marked as 47b.

To allow the top of the frame 29a to rotate if the wind is coming from the side at each end of the lemon shaped balloon would be wheels marked as 44 that would travel along a circular track which are constructed as a complete circle as shown as 29a on FIG. 27.

The part of the frame 29a carrying the track for the wheels 44 is shown by 43.

The balloon is shown by 4, the propellers that rotate when the wind makes contact are shown by 1 and the driver gear by 12a and the driven gear by 12b.

The effect of the wind on the balloon is absorbed by the rotation of the balloon both sideways and as a roll.

The propeller 1 connected for example on the driver gear 12a would use that wind energy to drive the driven gear 12b to move the structure forward in that direction. To move the other way the driven gear would use the wind to drive the driver gear 12b. The gears would work in reverse to change direction.

As shown in FIG. 28 to allow the top part of the frame 29a to rotate freely without negating the work of the propellers 1 to move the structure in the desired direction the bottom of the frame shown by 29b which was connected to the propellers 1 and the driver gear 12a and driven gear 12b could rotate using a joint to allow free movement shown by 45 in FIG. 28. The way it might rotate is shown by the arrows 45a.

This joint could be engaged so that it became rigidly fixed or released and the worm gears 12a and 12b could work in a synchronised way to assist the movement required for the whole structure.

1-14. (canceled)

15. Wind energy conversion apparatus comprising a lighter than air structure which is rotated by the wind to drive an electric generator which is located within the structure, the structure being untethered and wherein its rotation absorbs substantially all of the force of the wind so that its position can be maintained in a desired position.

16. Wind energy conversion apparatus according to claim 15 wherein the electricity is transferred from the structure by microwaves.

17. Wind energy conversion apparatus according to claim 15 wherein the height of the structure can be adjusted by heating gases within.

18. Wind energy conversion apparatus according to claim 15 wherein the apparatus can lower part of the structure to the ground or a desired point near the ground.

19. A structure where the free rotation of the blade can be slowed or stopped so that the wind or some of it passes though the blade and less or no wind energy is absorbed by the rotation of the blade and therefore makes contact with a structure behind the blade, exerting pressure on this part of the structure and causing anything attached to it to move.

20. A structure according to claim 19 where the synchronized braking and releasing of freely moving turbine blades which are attached to each other but set at different angles can cause the wind to have greater effect on some of the blades relative to others and thereby exert pressure on this structure and anything attached to move it in different directions.

21. An apparatus according to claim 19 where energy can be redirected from where it may have a negative effect to a different direction where it may have a positive effect where the greater the energy in the direction not desired, the greater the potential energy in the desired direction, with the former generating the power at the level needed for the latter without the need for a large amount of additional power to be generated by an external source to achieve this result.

22. A Wind energy conversion apparatus comprising a wind turbine supported by, or integral with, a lighter-than-air structure, the part of the turbine that rotates being rotated by the wind whilst at the same time absorbing substantially all of the force of the wind so that the position of the apparatus can be maintained.

23. A Wind energy conversion apparatus according to claim 22 wherein the apparatus is one of the group comprising tethered and untethered.

24. A Wind energy conversion apparatus according to claim 22 that is mobile.

25. A wind energy conversion apparatus according to claim 22 wherein the force of the wind against the lighter-than-air structure is utilized in the generation of electricity as the wind is caught by parts of the structure so as to make the structure revolve and hence drive an attached generator to produce electricity.

26. A wind energy conversion apparatus according to claim 22 wherein one or more revolving turbine blades are attached to the structure and shields or covers the entire side of the structure that has first contact with the wind so that as the blade(s) revolve(s), the wind is absorbed.

27. A wind energy conversion apparatus according to claim 22 where the energy of the wind can be absorbed by a turbine blade or blades that shields substantially all of one or more sides of the structure and where the turbine blade or blades rotate as the wind makes contact and hence absorb the wind energy and prevents it from exerting pressure against the side of the structure.

28. A wind energy conversion apparatus according to claim 26 where the position of the lighter-than-air structure can be changed by braking rotation of the turbine blade(s) to allow the wind, which would otherwise be absorbed, to exert more pressure against the side of the structure which supports the turbine blade(s), with the result that the lighter-than-air structure is pushed, under control, by the wind away from the side where the turbine blades have had their rotation braked.

29. A wind energy conversion apparatus according to claim 22 where the wind energy makes turbine blades rotate on one or more sides of the structure and this energy being transferred using gears, pulleys and/or belts to propellers to make the lighter than-air structure move.

30. A wind energy conversion apparatus according to claim 22 where the wind energy makes a turbine blade, or blades, rotate on one or more sides of the structure and this energy is transferred using gears, pulleys and/or belts to a shaft to make one or more generators generate electricity so that the apparatus has a larger number of turbines relative to the number of generators.

31. A wind energy conversion apparatus according to claim 22 where the height of the lighter-than-air structure can be adjusted by heating gases within the structure.

32. A wind energy conversion apparatus according to claim 22 where the apparatus can lower part of the structure to the ground or to a desired point nearer the ground

33. A wind energy conversion apparatus according to claim 22 where the wind energy makes the lighter-than-air structure rotate and this energy being transferred using gears, pulleys and/or belts to propellers to make the assembly move.

34. A wind energy conversion apparatus according to claim 22 where the wind energy makes the lighter-than-air structure rotate, turbine blades being provided which can be braked to control the position of the assembly.
